(19) United States
(12) Patent Application Publication
(10) Pub. No.: US 2026/0049588 A1
(43) Pub. Date: Feb. 19, 2026

(54) ENGINE FUEL NOZZLE WITH MULTIPLE FUEL JETS

(71) Applicant: Pratt & Whitney Canada Corp., Longueuil (CA)

(72) Inventor: Si-Man Lao, Mississauga (CA)

(21) Appl. No.: 18/807,431

(22) Filed: Aug. 16, 2024

(51) Int. Cl. F02M 61/18; F23R 3/28

(52) U.S. Cl. CPC F02M 61/1806; F23R 3/28

(57) ABSTRACT

An apparatus is provided for an engine. This apparatus includes a fuel nozzle extending axially along an axis to a distal end of the fuel nozzle. The fuel nozzle includes a plurality of fuel passages arranged circumferentially around the axis. The fuel passages includes a first fuel passage and a second fuel passage. The first fuel passage includes a first passage outlet axially aligned with an outlet location along the axis. The first fuel passage extends longitudinally within the fuel nozzle to the first passage outlet. A trajectory of the first fuel passage at the first passage outlet points to a target location along the axis that is axially spaced from the outlet location. The second fuel passage includes a second passage outlet. The second fuel passage extends longitudinally within the fuel nozzle to the second passage outlet. A trajectory of the second fuel passage at the second passage outlet points to the target location.

### TECHNICAL FIELD

This disclosure relates generally to an engine and, more particularly, to a fuel nozzle for the engine.

### BACKGROUND INFORMATION

An engine such as a gas turbine engine may include multiple fuel injector nozzles for injecting fuel into a combustion chamber. Various types and configurations of fuel injector nozzles are known in the art. While these known fuel injector nozzles have various benefits, there is still room in the art for improvement.

### SUMMARY

According to an aspect of the present disclosure, an apparatus is provided for an engine. This apparatus includes a fuel nozzle extending axially along an axis to a distal end of the fuel nozzle. The fuel nozzle includes a plurality of fuel passages arranged circumferentially around the axis. The fuel passages includes a first fuel passage and a second fuel passage. The first fuel passage includes a first passage outlet axially aligned with an outlet location along the axis. The first fuel passage extends longitudinally within the fuel nozzle to the first passage outlet. A trajectory of the first fuel passage at the first passage outlet points to a target location along the axis that is axially spaced from the outlet location. The second fuel passage includes a second passage outlet. The second fuel passage extends longitudinally within the fuel nozzle to the second passage outlet. A trajectory of the second fuel passage at the second passage outlet points to the target location.

According to another aspect of the present disclosure, another apparatus is provided for an engine. This apparatus includes a fuel nozzle extending axially along an axis to a distal end of the fuel nozzle. The fuel nozzle includes a plurality of fuel passages arranged circumferentially around the axis. The fuel passages includes a first fuel passage and a second fuel passage. The first fuel passage includes a first passage outlet disposed at the distal end of the fuel nozzle. The first fuel passage extends longitudinally within the fuel nozzle to the first passage outlet. A trajectory of the first fuel passage at the first passage outlet points to a target location that is axially spaced from the distal end of the fuel nozzle. The second fuel passage includes a second passage outlet disposed at the distal end of the fuel nozzle. The second fuel passage extends longitudinally within the fuel nozzle to the second passage outlet. A trajectory of the second fuel passage at the second passage outlet points to the target location.

According to still another aspect of the present disclosure, another apparatus is provided for an engine. This apparatus includes a fuel nozzle extending axially along an axis to a distal end of the fuel nozzle. The fuel nozzle includes a plurality of fuel passages arranged circumferentially around the axis. The fuel passages include a first fuel passage and a second fuel passage. The first fuel passage includes a first passage outlet. The first fuel passage extends longitudinally within the fuel nozzle to the first passage outlet. A trajectory of the first fuel passage at the first passage outlet points to a target location. The trajectory of the first fuel passage at the first passage outlet is angularly offset from the axis by an acute first offset angle. The second fuel passage includes a second passage outlet. The second fuel passage extends longitudinally within the fuel nozzle to the second passage outlet. A trajectory of the second fuel passage at the second passage outlet points to the target location. The trajectory of the second fuel passage at the second passage outlet is angularly offset from the axis by an acute second offset angle.

The acute second offset angle may be equal to the acute first offset angle.

The acute first offset angle and the acute second offset angle may each be between ten degrees and eighty degrees.

The fuel passages may be equispaced circumferentially around the axis.

The second passage outlet may be axially aligned with the outlet location along the axis.

The first passage outlet may be located a first radial distance from the axis. The second passage outlet may be located a second radial distance from the axis that is equal to the first radial distance.

The trajectory of the first fuel passage at the first passage outlet may be angularly offset from the axis by an offset angle. The offset angle may be between ten degrees and thirty degrees.

The trajectory of the first fuel passage at the first passage outlet may be angularly offset from the axis by an offset angle. The offset angle may be between thirty degrees and sixty degrees.

The trajectory of the first fuel passage at the first passage outlet may be angularly offset from the axis by an offset angle. The offset angle may be between sixty degrees and eighty degrees.

The trajectory of the first fuel passage at the first passage outlet may be angularly offset from the axis by a first offset angle. The trajectory of the second fuel passage at the second passage outlet may be angularly offset from the axis by a second offset angle that is equal to the first offset angle.

The fuel passages may also include a third fuel passage. The third fuel passage may include a third passage outlet. The third fuel passage may extend longitudinally within the fuel nozzle to the third passage outlet. A trajectory of the third fuel passage at the third passage outlet may point to the target location.

The first passage outlet and the second passage outlet may be disposed at the distal end of the fuel nozzle.

An entirety of the distal end of the fuel nozzle located radially inboard of at least one of the first passage outlet or the second passage outlet may be uninterrupted by another passage outlet.

The first passage outlet and the second passage outlet may be formed in a concave face surface of the fuel nozzle.

An apex of the concave face surface may be coincident with the axis.

The apparatus may also include a fuel system configured to deliver gaseous fuel to the fuel passages.

The apparatus may also include a fuel system configured to deliver fuel to the fuel passages. The fuel may be hydrogen (H₂) fuel.

The apparatus may also include a compressor section, a combustor section, a turbine section and a flowpath. The combustor section may include the fuel nozzle. The flowpath may extend through the compressor section, the combustor section and the turbine section from an inlet into the flowpath to an exhaust from the flowpath.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a partial schematic sectional illustration of an aircraft propulsion system.

FIG. 2 is a partial schematic illustration of the aircraft propulsion system at a combustor section.

FIG. 3 is a partial schematic sectional illustration of a fuel injector nozzle at an interface with a combustor wall.

FIG. 4 is an end view illustration of the fuel injector nozzle.

### DETAILED DESCRIPTION

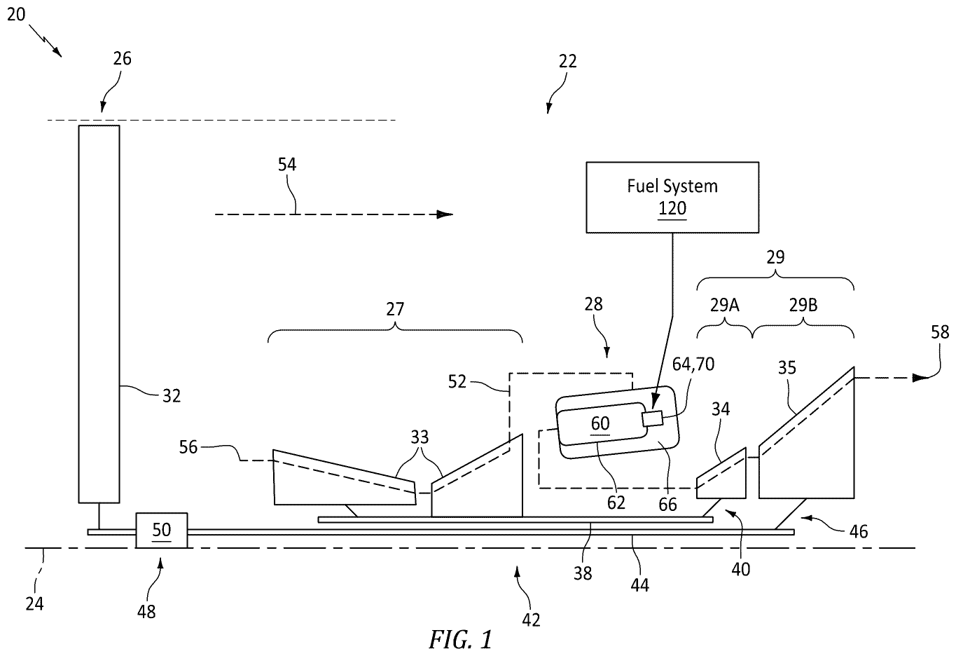

FIG. 1 illustrates a propulsion system 20 for an aircraft with a gas turbine engine 22. The aircraft may be an airplane, a rotorcraft (e.g., a helicopter), a drone (e.g., an unmanned aerial vehicle (UAV)), or any other manned or unmanned aerial vehicle or system. For ease of description, the aircraft propulsion system 20 is described below as a turbofan propulsion system, and the turbine engine 22 is described below as a turbofan engine. The present disclosure, however, is not limited to such an exemplary aircraft propulsion system nor to such an exemplary turbine engine. The aircraft propulsion system 20, for example, may alternatively be configured as a turbojet propulsion system, a turboprop propulsion system, a turboshaft propulsion system or an open rotor propulsion system. Moreover, the present disclosure is not limited to propulsion system applications. The turbine engine 22, for example, may alternatively be configured as or included as part of an auxiliary power unit (APU) for the aircraft or a ground-based (e.g., industrial) electrical power system.

The turbine engine 22 of FIG. 1 extends axially along an engine axis 24 between a forward, upstream end of the turbine engine 22 and an aft, downstream end of the turbine engine 22. Briefly, the engine axis 24 may be a centerline axis of the turbine engine 22 and/or one or more of its members. The engine axis 24 may also or alternatively be a rotational axis for one or more members of the turbine engine 22. The turbine engine 22 of FIG. 1 includes a propulsor section 26 (e.g., a fan section), a compressor section 27, a combustor section 28 and a turbine section 29. The turbine section 29 of FIG. 1 includes a high pressure turbine (HPT) section 29A and a low pressure turbine (LPT) section 29B, which LPT section 29B may be a power turbine (PT) section dedicated to powering operation of the propulsor section 26.

The engine sections 26-29B may be arranged sequentially along the engine axis 24. The propulsor section 26 includes a bladed propulsor rotor 32; e.g., a fan rotor. The compressor section 27 includes a bladed compressor rotor 33. The HPT section 29A includes a bladed high pressure turbine (HPT) rotor 34. The LPT section 29B includes a bladed low pressure turbine (LPT) rotor 35, which LPT rotor 35 may be a power turbine (PT) rotor. The propulsor rotor 32, the compressor rotor 33, the HPT rotor 34 and the LPT rotor 35 each respectively include one or more arrays (e.g., stages) of rotor blades, where the rotor blades in each array are arranged circumferentially around and are connected to a respective rotor disk or hub. The rotor blades in each array, for example, may be formed integral with or mechanically fastened, welded, brazed and/or otherwise attached to the respective rotor disk and/or hub.

The compressor rotor 33 is coupled to and rotatable with the HPT rotor 34. The compressor rotor 33 of FIG. 1, for example, is connected to the HPT rotor 34 by a high speed shaft 38. At least (or only) the compressor rotor 33, the HPT rotor 34 and the high speed shaft 38 collectively form a high speed rotating assembly 40; e.g., a high speed spool of a core 42 of the turbine engine 22. Briefly, the engine core 42 of FIG. 1 includes the compressor section 27, the combustor section 28 and the turbine section 29.

The LPT rotor 35 of FIG. 1 is connected to a low speed shaft 44. At least (or only) the LPT rotor 35 and the low speed shaft 44 collectively form a low speed rotating assembly 46; e.g., a low speed spool of the engine core 42. This low speed rotating assembly 46 is further coupled to the propulsor rotor 32 through a drivetrain 48. This drivetrain 48 may be configured as a geared drivetrain, where a geartrain 50 (e.g., a transmission, a speed change device, an epicyclic geartrain, etc.) is disposed between and operatively couples the propulsor rotor 32 to the low speed rotating assembly 46 and its LPT rotor 35. With this arrangement, the propulsor rotor 32 may rotate at a different (e.g., slower) rotational velocity than the low speed rotating assembly 46 and its LPT rotor 35. However, the drivetrain 48 may alternatively be configured as a direct drive drivetrain, where the geartrain 50 is omitted. With such an arrangement, the propulsor rotor 32 rotates at a common (the same) rotational velocity as the low speed rotating assembly 46 and its LPT rotor 35. Referring again to FIG. 1, each of the rotating assemblies 40, 46 and its members as well as the propulsor rotor 32 may be rotatable about the engine axis 24. The present disclosure, however, is not limited to such an exemplary engine arrangement.

The turbine engine 22 of FIG. 1 includes a (e.g., annular) core flowpath 52 and a (e.g., annular) bypass flowpath 54. Here, the bypass flowpath 54 is a ducted flowpath within the aircraft propulsion system 20 and its turbine engine 22. The bypass flowpath 54, however, may alternatively be an open flowpath where the propulsor rotor 32 is alternatively configured as an un-ducted propulsor rotor; e.g., a propeller rotor, a rotorcraft rotor, an open rotor, etc. Referring again to FIG. 1, the core flowpath 52 extends within the turbine engine 22 and its engine core 42 from an airflow inlet 56 into the core flowpath 52 to a combustion products exhaust 58 from the core flowpath 52. More particularly, the core flowpath 52 extends from the core inlet 56, sequentially through the compressor section 27, the combustor section 28, the HPT section 29A and the LPT section 29B, to the core exhaust 58. The bypass flowpath 54 of FIG. 1 extends outside of the engine core 42 thereby bypassing the engine core 42 and its engine sections 27-29B.

During operation of the turbine engine 22 of FIG. 1, air is directed across the propulsor rotor 32 and into the engine core 42 through the core inlet 56. This air entering the core flowpath 52 may be referred to as core air. The core air is compressed by the compressor rotor 33 and directed into a combustion chamber 60 (e.g., an annular combustion chamber) within a combustor 62 (e.g., an annular combustor) of the combustor section 28. Fuel is injected into the combustion chamber 60 by one or more fuel injectors 64 and mixed with the compressed core air to provide a fuel-air mixture. This fuel-air mixture is ignited and combustion products thereof flow through and sequentially drive rotation of the HPT rotor 34 and the LPT rotor 35. The rotation of the HPT rotor 34 drives rotation of the compressor rotor 33 and, thus, the compression of the air received from the core inlet 56. The rotation of the LPT rotor 35 drives rotation of the propulsor rotor 32. The rotation of the propulsor rotor 32 of FIG. 1 propels some of the air flow thereacross (e.g., the air not entering the engine core 42) through the bypass flowpath 54 to provide engine thrust.

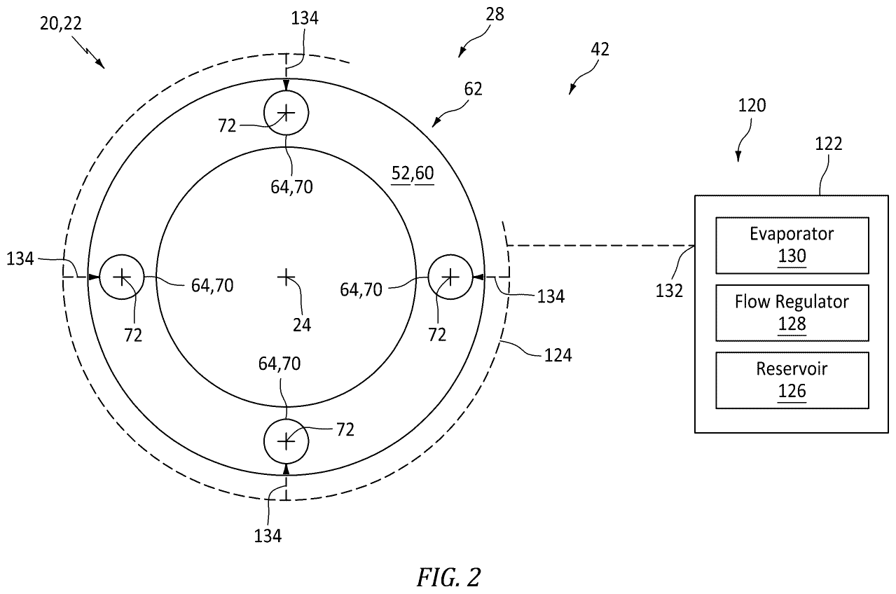

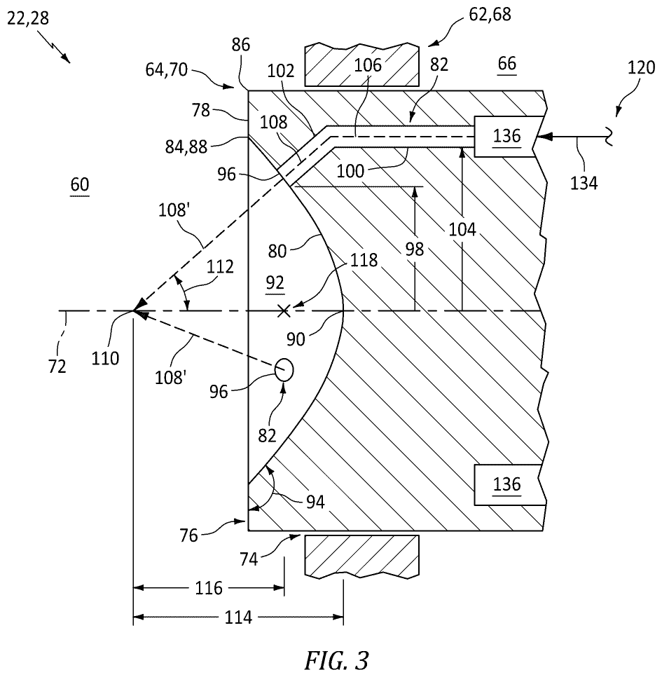

Referring to FIG. 2, the fuel injectors 64 are arranged and may be equispaced circumferentially about the engine axis 24 in an annular array; e.g., a circular array. Referring to FIG. 3, each of the fuel injectors 64 may extend across a diffuser plenum 66 surrounding the combustor 62 to a wall 68 of the combustor 62. Briefly, the combustor wall 68 may be a sidewall of the combustor 62 or a bulkhead wall of the combustor 62 depending on the specific combustor configuration and/or fuel injector placement. Each of the fuel injectors 64 includes a fuel nozzle 70 mated with the combustor wall 68. The fuel nozzle 70 of FIG. 3, for example, projects axially along a nozzle axis 72 through (or partially into) a port 74 in the combustor wall 68 to a distal end 76 (e.g., a tip, a face, etc.) of the fuel nozzle 70, which nozzle axis 72 may be a centerline axis of the fuel nozzle 70. The nozzle distal end 76 is thereby located within (or adjacent) the combustion chamber 60. The fuel nozzle 70 of FIG. 3 includes one or more nozzle face surfaces 78 and 80 and a plurality of fuel passages 82; e.g., gaseous fuel passages.

The nozzle face surfaces 78 and 80 of FIG. 3 are located at (e.g., on, adjacent or proximate) the nozzle distal end 76. The outer nozzle face surface 78 and the inner nozzle face surface 80 of FIG. 3, for example, may collectively define the nozzle distal end 76.

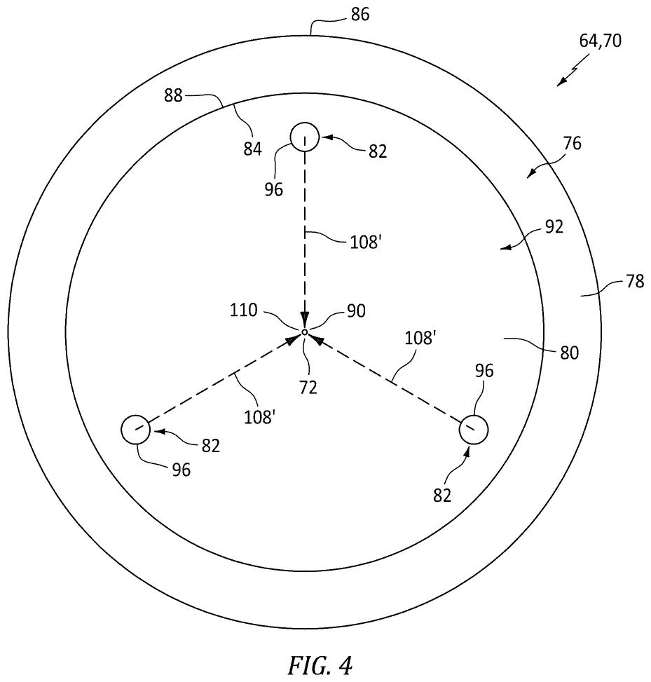

The outer nozzle face surface 78 is disposed radially outboard of the inner nozzle face surface 80. The outer nozzle face surface 78 extends radially from a (e.g., circular) radial inner edge 84 of the outer nozzle face surface 78 to a (e.g., circular) radial outer edge 86 of the outer nozzle face surface 78. Referring to FIG. 4, the outer nozzle face surface 78 extends circumferentially about (e.g., completely around) the nozzle axis 72. The outer nozzle face surface 78 may thereby have a full-hoop (e.g., annular) geometry that circumscribes the inner nozzle face surface 80. Referring to FIG. 3, the outer nozzle face surface 78 may be a flat, planar surface. The outer nozzle face surface 78 may be configured without any radial and/or circumferential interruptions. The outer nozzle face surface 78 of FIG. 3 is angularly offset from the nozzle axis 72 by an offset angle when viewed, for example, in a reference plane parallel to (e.g., including) the nozzle axis 72; e.g., a plane of FIG. 3. This outer nozzle face surface offset angle of FIG. 3 is a right angle—a ninety degree (90°) angle. The present disclosure, however, is not limited to such an exemplary outer nozzle face surface configuration. For example, for certain combustor environments, the outer nozzle face surface 78 may alternatively be convex, concave and/or otherwise contoured; e.g., frustoconical, etc.

The inner nozzle face surface 80 is disposed radially inboard of the outer nozzle face surface 78. The inner nozzle face surface 80 extends radially out from the nozzle axis 72 to a (e.g., circular) radial outer edge 88 of the inner nozzle face surface 80. Referring to FIG. 4, the inner nozzle face surface 80 extends circumferentially about (e.g., completely around) the nozzle axis 72. The inner nozzle face surface 80 may thereby have a non-annular, full-hoop geometry. Referring to FIG. 3, the inner nozzle face surface 80 may be a concave face surface; e.g., a partially-spherical face surface. The inner nozzle face surface 80 of FIG. 3, for example, has a curved sectional geometry (e.g., a circular-segment shaped geometry) when viewed, for example, in the reference plane. The inner nozzle face surface 80 and its curved sectional geometry may have an apex 90 coincident with the nozzle axis 72. At the apex 90/at a point coincident with the nozzle axis 72, the inner nozzle face surface 80 may be perpendicular to the nozzle axis 72. At the inner nozzle face surface outer edge 88, the inner nozzle face surface 80 may be angularly offset from the nozzle axis 72 by an offset angle less than ninety degrees (90°); e.g., between ten degrees (10°) and eighty degrees (80°).

The inner nozzle face surface 80 of FIG. 3 forms a pocket 92 in the fuel nozzle 70 at its nozzle distal end 76. This pocket 92 projects axially along the nozzle axis 72 into the fuel nozzle 70 from the inner nozzle face surface outer edge 88 (and the outer nozzle face surface 78) to the apex 90 of the inner nozzle face surface 80. The pocket 92 extends radially within the fuel nozzle 70 between diametrically opposing sides of the inner nozzle face surface 80. The pocket 92 also extends circumferentially about (e.g., completely around) the nozzle axis 72.

At the inner nozzle face surface outer edge 88, the inner nozzle face surface 80 may be contiguous with the outer nozzle face surface 78. The inner nozzle face surface outer edge 88 of FIG. 3, for example, meets the outer nozzle face surface inner edge 84 at an outside corner between the inner nozzle face surface 80 and the outer nozzle face surface 78. At this corner/inter-surface interface, the inner nozzle face surface 80 is angularly offset from the outer nozzle face surface 78 by an inter-surface offset angle 94 less than one-hundred and eighty degrees (180°); e.g., between one-hundred degrees (100°) and one-hundred and seventy degrees (170°).

The inner nozzle face surface 80 may be configured without any radial and/or circumferential interruptions besides respective fuel passage outlets 96 from the fuel passages 82. For example, an entirety of the inner nozzle face surface 80/the nozzle distal end 76 located radially inboard of the passage outlets 96 (relative to the nozzle axis 72) may be uninterrupted by other apertures; e.g., other fuel passage outlets, air passage outlets, etc. The passage outlets 96 may thereby be the radially innermost apertures formed by and disposed in the inner nozzle face surface 80 and, more generally, the nozzle distal end 76 as described below in further detail. More particularly, the passage outlets 96 may be the only apertures formed by and disposed in the inner nozzle face surface 80, or more generally the nozzle distal end 76.

Referring to FIG. 4, the fuel passages 82 and their passage outlets 96 are arranged and may be equispaced circumferentially around the nozzle axis 72 in an annular array; e.g., a circular array. Referring to FIG. 3, each fuel passage 82 extend longitudinally within the fuel nozzle 70 to its respective passage outlet 96. Briefly, each passage outlet 96 is formed by and disposed in (e.g., pierces) the inner nozzle face surface 80. Each passage outlet 96 is located and is radially spaced a (e.g., common) radial distance 98 from the nozzle axis 72. However, it is contemplated the passage outlets 96 may alternatively be radially spaced from the nozzle 72 at different radial distances in other embodiments. Each passage outlet 96 of FIG. 3 may be disposed closer to the inner nozzle face surface outer edge 88 than the apex 90 as measured along a curvature of the inner nozzle face surface 80 when viewed, for example, in the reference plane. Each fuel passage 82 of FIG. 3 includes an upstream section 100 and a downstream section 102.

The passage upstream section 100 extends longitudinally within the fuel nozzle 70 to an upstream end of the passage downstream section 102. This passage upstream section 100 is located and is radially spaced a (e.g., common) radial distance 104 from the nozzle axis 72, where the upstream section radial distance 104 of FIG. 3 is greater than the outlet radial distance 98. The passage upstream section 100 is thereby disposed radially outboard of the respective passage outlet 96 relative to the nozzle axis 72. A centerline 106 of each fuel passage 82 along its passage upstream section 100, at least adjacent the passage downstream section 102, may follow a straight-line trajectory. This passage centerline 106 may also be parallel with the nozzle axis 72 when viewed, for example, in the reference plane. The present disclosure, however, is not limited to such an exemplary passage upstream section configuration.

The passage downstream section 102 extends longitudinally within the fuel nozzle 70 from a downstream end of the passage upstream section 100 to its respective passage outlet 96. The passage centerline 106 of each fuel passage 82 along its passage downstream section 102, at least adjacent the respective passage outlet 96, follows a trajectory 108 which points to a common target location 110 along the nozzle axis 72. In other words, if the passage downstream section trajectory 108 was extended out from the respective passage outlet 96, this extended passage downstream section trajectory 108′ would be coincident with the nozzle axis 72 at the target location 110. The passage downstream section trajectory 108 and the passage centerline 106, at least at the respective passage outlet 96, are angularly offset from the nozzle axis 72 by an offset angle 112; e.g., a non-zero acute angle. This trajectory offset angle 112 may be selected between ten degrees (10°) and thirty degrees (30°), for example to promote deeper fuel penetration into the combustion chamber 60. The trajectory offset angle 112 may be selected between sixty degrees (60°) and eighty degrees (80°), for example to promote shallower fuel penetration into the combustion chamber 60. The trajectory offset angle 112 may be selected between thirty degrees (30°) and sixty degrees (60°), for example to promote intermediate fuel penetration into the combustion chamber 60.

The target location 110 is located and is axially spaced a first axial distance 114 from the apex 90. The target location 110 is also located and is axially spaced a second (e.g., shorter) axial distance 116 from an axial outlet location 118 along the nozzle axis 72, which outlet location 118 is axially aligned with the passage outlets 96 along the nozzle axis 72. Thus, the target location 110 of FIG. 3 is disposed within the combustion chamber 60 and away from the nozzle distal end 76. Note, while the fuel passages 82 and their passage outlets 96 are symmetrically arranged and the target location 110 of FIG. 3 is disposed along the nozzle axis 72, the present disclosure is not limited thereto. It is contemplated, for example, the fuel passages 82 and/or their passage outlets 96 may be asymmetrically arranged and the target location 110 may be non-coincident with (e.g., disposed slightly radially to a side of) the nozzle axis 72 in other embodiments.

Referring to FIG. 2, the aircraft propulsion system 20 includes a fuel system 120 is configured to deliver gaseous fuel to the fuel injectors 64 and their fuel nozzles 70 for injection into the combustion chamber 60 as described above. For ease of description, the gaseous fuel is described below as a gaseous hydrogen fuel; e.g., hydrogen (H₂) gas. The gaseous fuel, however, may alternatively be another gaseous fuel such as, but not limited to, gaseous methane (e.g., natural gas), propane gas or the like. Although, it is contemplated select liquid fuels may alternatively be delivered to the fuel injectors 64 and their fuel nozzles 70 for injection into the combustion chamber 60. Referring again to FIG. 2, the fuel system 120 includes a (e.g., gaseous) fuel source 122 and a (e.g., gaseous) fuel manifold 124.

The fuel source 122 of FIG. 2 includes a fuel reservoir 126, a fuel flow regulator 128 and a fuel evaporator 130. The fuel reservoir 126 is configured to store a quantity of fuel (e.g., in its liquid phase) before, during and/or after aircraft powerplant operation. The fuel reservoir 126, for example, may be configured as or otherwise include a tank, a cylinder, a pressure vessel, a bladder or any other type of (e.g., insulated) fuel storage container. The fuel flow regulator 128 is configured to direct a flow of the fuel (e.g., in its liquid phase) from the fuel reservoir 126 to the fuel evaporator 130. The fuel flow regulator 128, for example, may be configured as or otherwise include a fuel compressor, a fuel pump and/or a fuel valve (or valve system). The fuel evaporator 130 is configured to facilitate evaporation of the fuel from its liquid phase to a gaseous phase so as to output the gaseous fuel from an outlet 132 of the fuel source 122. This fuel source outlet 132 may be fluidly coupled to each of the fuel injectors 64 and their fuel nozzles 70 sequentially through the fuel manifold 124 and a respective (e.g., gaseous) fuel feed passage 134. Referring to FIG. 3, each fuel feed passage 134 may be fluidly coupled, in parallel, to the fuel passages 82 of a respective one of the fuel nozzles 70 through an intermediate fuel plenum 136 (e.g., an annular chamber, a gallery, etc.) within the respective fuel nozzle 70.

During turbine engine operation, each fuel nozzle 70 receives the gaseous fuel from the fuel system 120 (see FIG. 2). This gaseous fuel is directed through each of the fuel passages 82 within the respective fuel nozzle 70 for injection into the combustion chamber 60. More particularly, each of the fuel passages 82 within the respective fuel nozzle 70 directs a jet of the gaseous fuel out of the respective fuel nozzle 70 via the respective passage outlet 96 and into the combustion chamber 60 along the extended passage downstream section trajectory 108′ to the target location 110. At the target location 110, the multiple jets of the gaseous fuel collide (see also FIG. 4). This collision reduces a velocity of the injected gaseous fuel axially along the nozzle axis 72. The collision also promotes mixing between the multiple jets of the gaseous fuel as well as mixing between the gaseous fuel and the compressed core air directed into the combustion chamber 60 from the diffuser plenum 66 (see FIG. 2). The gaseous fuel may thereby be injected into the combustion chamber 60 at a relatively high pressure without moving a mixing and combustion region too deep into the combustion chamber 60. At the same time, the target location 110 may be selected to be deep enough into the combustion chamber 60 to reduce or prevent flashback and/or flame holding.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

What is claimed is:

1. An apparatus for an engine, comprising:
a fuel nozzle extending axially along an axis to a distal end of the fuel nozzle, the fuel nozzle including a plurality of fuel passages arranged circumferentially around the axis, and the plurality of fuel passages including a first fuel passage and a second fuel passage;
the first fuel passage comprising a first passage outlet axially aligned with an outlet location along the axis, the first fuel passage extending longitudinally within the fuel nozzle to the first passage outlet, and a trajectory of the first fuel passage at the first passage outlet pointing to a target location along the axis that is axially spaced from the outlet location; and
the second fuel passage comprising a second passage outlet, the second fuel passage extending longitudinally within the fuel nozzle to the second passage outlet, and a trajectory of the second fuel passage at the second passage outlet pointing to the target location.

2. The apparatus of claim 1, wherein the plurality of fuel passages are equispaced circumferentially around the axis.

3. The apparatus of claim 1, wherein the second passage outlet is axially aligned with the outlet location along the axis.

4. The apparatus of claim 1, wherein
the first passage outlet is located a first radial distance from the axis; and
the second passage outlet is located a second radial distance from the axis that is equal to the first radial distance.

5. The apparatus of claim 1, wherein the trajectory of the first fuel passage at the first passage outlet is angularly offset from the axis by an offset angle, and the offset angle is between ten degrees and thirty degrees.

6. The apparatus of claim 1, wherein the trajectory of the first fuel passage at the first passage outlet is angularly offset from the axis by an offset angle, and the offset angle is between thirty degrees and sixty degrees.

7. The apparatus of claim 1, wherein the trajectory of the first fuel passage at the first passage outlet is angularly offset from the axis by an offset angle, and the offset angle is between sixty degrees and eighty degrees.

8. The apparatus of claim 1, wherein
the trajectory of the first fuel passage at the first passage outlet is angularly offset from the axis by a first offset angle; and
the trajectory of the second fuel passage at the second passage outlet is angularly offset from the axis by a second offset angle that is equal to the first offset angle.

9. The apparatus of claim 1, wherein
the plurality of fuel passages further include a third fuel passage;
the third fuel passage comprises a third passage outlet;
the third fuel passage extends longitudinally within the fuel nozzle to the third passage outlet; and
a trajectory of the third fuel passage at the third passage outlet points to the target location.

10. The apparatus of claim 1, wherein the first passage outlet and the second passage outlet are disposed at the distal end of the fuel nozzle.

11. The apparatus of claim 10, wherein an entirety of the distal end of the fuel nozzle located radially inboard of at least one of the first passage outlet or the second passage outlet is uninterrupted by another passage outlet.

12. The apparatus of claim 1, wherein the first passage outlet and the second passage outlet are formed in a concave face surface of the fuel nozzle.

13. The apparatus of claim 12, wherein an apex of the concave face surface is coincident with the axis.

14. The apparatus of claim 1, further comprising a fuel system configured to deliver gaseous fuel to the plurality of fuel passages.

15. The apparatus of claim 1, further comprising a fuel system configured to deliver fuel to the plurality of fuel passages, and the fuel comprising hydrogen (H₂) fuel.

16. The apparatus of claim 1, further comprising:
a compressor section;
a combustor section comprising the fuel nozzle;
a turbine section; and
a flowpath extending through the compressor section, the combustor section and the turbine section from an inlet into the flowpath to an exhaust from the flowpath.

17. An apparatus for an engine, comprising:
a fuel nozzle extending axially along an axis to a distal end of the fuel nozzle, the fuel nozzle including a plurality of fuel passages arranged circumferentially around the axis, and the plurality of fuel passages including a first fuel passage and a second fuel passage;
the first fuel passage comprising a first passage outlet disposed at the distal end of the fuel nozzle, the first fuel passage extending longitudinally within the fuel nozzle to the first passage outlet, and a trajectory of the first fuel passage at the first passage outlet pointing to a target location that is axially spaced from the distal end of the fuel nozzle; and
the second fuel passage comprising a second passage outlet disposed at the distal end of the fuel nozzle, the second fuel passage extending longitudinally within the fuel nozzle to the second passage outlet, and a trajectory of the second fuel passage at the second passage outlet pointing to the target location.

18. An apparatus for an engine, comprising:
a fuel nozzle extending axially along an axis to a distal end of the fuel nozzle, the fuel nozzle including a plurality of fuel passages arranged circumferentially around the axis, and the plurality of fuel passages including a first fuel passage and a second fuel passage;
the first fuel passage comprising a first passage outlet, the first fuel passage extending longitudinally within the fuel nozzle to the first passage outlet, a trajectory of the first fuel passage at the first passage outlet pointing to a target location, and the trajectory of the first fuel passage at the first passage outlet angularly offset from the axis by an acute first offset angle; and
the second fuel passage comprising a second passage outlet, the second fuel passage extending longitudinally within the fuel nozzle to the second passage outlet, a trajectory of the second fuel passage at the second passage outlet pointing to the target location, and the trajectory of the second fuel passage at the second passage outlet angularly offset from the axis by an acute second offset angle.

19. The apparatus of claim 18, wherein the acute second offset angle is equal to the acute first offset angle.

20. The apparatus of claim 18, wherein the acute first offset angle and the acute second offset angle are each between ten degrees and eighty degrees.
